(19) United States
(12) Patent Application Publication
(10) Pub. No.: US 2026/0218672 A1
(43) Pub. Date: Jul. 30, 2026

(54) HYDROGEN APPLICATION WITH COLLECTOR UNIT

(71) Applicant: ANGLO BELGIAN CORPORATION NV, Gent (BE)

(72) Inventors: Luc MATTHEEUWS, Gent (BE); Tim BERCKMOES, Gent (BE); Fréderick VAN DE VYVER, Gent (BE)

(21) Appl. No.: 19/140,043

(22) PCT Filed: Oct. 27, 2023
(86) PCT No.: PCT/IB2023/060844

§ 371 Date: Jun. 17, 2025

(30) Foreign Application Priority Data
Dec. 20, 2022 (BE) 2022/6044

(51) Int. Cl. F02M 21/02

(52) U.S. Cl. CPC F02M 21/0206; F02M 21/0239; F02M 21/0245; F02M 21/0296

(57) ABSTRACT

An apparatus suitable for a hydrogen application includes: a hydrogen preparation unit designed to supply a hydrogen-containing gaseous medium with at least 85 volume percent hydrogen at a pressure between a lower limit and an upper limit; a hydrogen collector unit comprising one or more pipe elements that together define an interior space bordered by a wall; a hydrogen processing unit adapted for processing and/or using the hydrogen-containing medium. The apparatus is configured to feed the hydrogen collector unit with the hydrogen-containing medium from the hydrogen preparation unit and to supply the hydrogen-containing medium from the hydrogen collector unit to the hydrogen processing unit, where the upper limit is at most 50 bar, and each of the one or more pipe elements is a casting made from nodular cast iron with a tensile strength of at most 600 MPa.

### TECHNICAL FIELD

The present invention relates generally to a collector in a hydrogen application, more specifically to a fuel rail in a hydrogen combustion engine. The invention supplies in particular a solution for a collector which, through suitable material selection, is sufficiently resistant to hydrogen embrittlement and at the same time allows a limited material cost and good feasibility.

### BACKGROUND OF THE INVENTION

In recent years, hydrogen has come to the fore as a promising alternative fuel and energy carrier. For example, as the drive system for vehicles, hydrogen combustion engines have been developed, in which hydrogen is used as fuel, and fuel cells have been developed in order to generate electrical energy using hydrogen.

However, the use of hydrogen in engines and other applications brings with it additional challenges at the level of the materials used in said systems. In fact, a substantial risk associated with the use of hydrogen is the development of hydrogen brittleness or hydrogen embrittlement: the phenomenon wherein hydrogen diffuses into the structure of the material, so that local embrittlement of the material occurs and there is a risk of cracking or brittle fracture. In particular, parameters that contribute to a certain activation energy, such as increased pressure or temperature, increase the risk of hydrogen embrittlement.

Consequently, special attention should be paid to the selection of suitable materials for components that are in contact with the hydrogen-containing medium during storage, transport or processing. For example, in a hydrogen combustion engine, the collector or fuel rail is a critical component. The fuel rail forms part of the hydrogen supply system, and provides temporary buffering of almost pure hydrogen, prior to mixing with air and supply of the hydrogen-air mixture to the cylinders. Within the collector or fuel rail, there are admittedly pressure levels that are not as high as for example is the case in a hydrogen storage tank, but since the wall of the collector is continuously in contact with almost pure hydrogen, there is a real risk of hydrogen embrittlement. Inspection requirements for such a component are accordingly especially strict, and it is required that at the highest pressure level that may possibly occur in the fuel rail, for example a pressure level of 10 bar, resistance to hydrogen embrittlement is guaranteed, even if the pressure level in nominal operation is lower, for example at 3.5 bar. The resistance to hydrogen embrittlement should in addition be guaranteed in the case of almost permanent exposure to hydrogen in the stationary state, even if in practice there is only brief buffering and flow of hydrogen in the fuel rail.

In general, in the prior art there is the teaching that certain more porous materials, for example such as cast iron, are not suitable for use in combination with hydrogen, on account of their high sensitivity to hydrogen embrittlement. For example, the online article titled “Identifying Unique Hydrogen Fuel Cell System Demands and How to Meet Them” (22 Oct. 2020, https://www.oemoffhighway.com/engines/fuels-fluids/fuel-tanks-systems/article/21199105/identifying-unique-hydrogen-fuel-cell-system-demands-and-how-to-meet-them), teaches about materials suitable for critical components in hydrogen fuel cells. In this it is stated that traditional stainless steel grades, of a lower grade, behave like cast iron, and so display a high risk of hydrogen embrittlement. Moreover, in the scientific article titled “Hydrogen embrittlement of nodular cast iron” (Patrik Sahiluoma et al., 2020), a ferritic nodular cast iron is investigated for sensitivity to hydrogen embrittlement, with a view to material selection for containers for long-term geological storage of spent nuclear fuel. From the experimental research conducted, which focuses on an elevated temperature as activator for hydrogen, it is concluded that the cast iron investigated is a grade of material with high sensitivity to hydrogen embrittlement.

In order to limit the risk of hydrogen embrittlement, it is thus proposed in the prior art to use specific high-grade materials in hydrogen applications. For example, the article titled “Review: Hydrogen Embrittlement of Metals and Alloys in Combustion Engines” (Maricruz Saborio González et al., 2017) gives an overview of materials that are used at present for various components in internal combustion engines, using hydrogen-enriched fuels. Generally it is stated herein that to avoid hydrogen permeability, non-porous materials should be selected. In particular, the use of specific metals, alloys and steel grades is recommended, for example aluminium, aluminium alloys, titanium steel, stainless steel, copper, bronze and monel metal, Inconel, titanium, austenitic stainless steel, alloy steel with titanium oxide and aluminium oxide.

In the aforementioned online article titled “Identifying Unique Hydrogen Fuel Cell System Demands and How to Meet Them” (22 Oct. 2020, https://www.oemoffhighway.com/engines/fuels-fluids/fuel-tanks-systems/article/21199105/identifying-unique-hydrogen-fuel-cell-system-demands-and-how-to-meet-them), materials are mentioned that are suitable for critical components in hydrogen fuel cells. In this it is recommended to use stainless steel grades of a higher grade, for example with a certain nickel content, which are more resistant to hydrogen embrittlement and so are more reliable as a choice of material for components in hydrogen fuel cells.

US2018/0058312A1 presents a “hydrogen fuel reformer”, which transforms a fuel into hydrogen, after which the hydrogen can for example be used in a fuel cell or can be supplied to a combustion chamber. Hydrogen leaving the reformer is at high temperature and must therefore be cooled in a so-called “fuel reformer cooler”. The hydrogen thus remains in the cooler temporarily, wherein the risk arises of diffusion of the hydrogen into the wall. In order to limit the risk of hydrogen embrittlement, in this patent application it is proposed to apply a special layer or coating. Examples of said “anti-hydrogen embrittlement layer” are a nitride film, such as a silicon nitride film, or a layer or coating of a nickel-based alloy.

To summarize, in the aforementioned prior art it is recommended to use, in combination with hydrogen, either high-grade materials, such as stainless steel and alloy steel grades, or to make use of special coatings. However, in this way, the decrease in sensitivity to hydrogen embrittlement is coupled with the introduction of additional drawbacks, for example at the level of cost and feasibility. In fact, high-grade materials such as stainless steel and alloy steel grades are expensive, so that—certainly in large engines—there is a substantial impact on cost price when these expensive materials have to be used. In addition, for a component such as the hydrogen collector or fuel rail, which are required to be of double-walled construction, preferably the double wall is made thin, so as to limit the amount of space occupied and facilitate integration of the collector in the engine. However, the aforementioned high-grade materials do not allow thin-walled casting, so that a component such as the collector has to be fabricated by welding. Consequently, a compact design of the collector and simple integration in the engine become difficult. Finally, any welds present always form a weak point in the fabricated component, which is a disadvantage in terms of robustness and durability.

An aim of the present invention is to describe a solution that overcomes one or more of the described drawbacks of solutions from the prior art. More specifically, it is an aim of the present invention to propose a collector in a hydrogen application, which through suitable material selection is sufficiently resistant to hydrogen embrittlement and at the same time gives a limited material cost and good feasibility.

### SUMMARY OF THE INVENTION

According to a first aspect of the present invention, the aims identified above are achieved with an apparatus suitable for a hydrogen application, wherein the apparatus comprises:
a hydrogen preparation unit adapted for supplying a hydrogen-containing gaseous medium with at least 85 volume percent hydrogen, at a pressure which, depending on the operating state of the apparatus, is between a lower limit and an upper limit, wherein the lower limit is less than or equal to the upper limit;
a hydrogen collector unit in communication with the hydrogen preparation unit, comprising one or more pipe elements, which together define an interior space delimited by a wall;
a hydrogen processing unit in communication with the hydrogen collector unit, adapted for the processing and/or use of the hydrogen-containing medium,
   wherein the apparatus is adapted for, during operation:
feeding the hydrogen collector unit with the hydrogen-containing medium from the hydrogen preparation unit, for flow and/or temporary buffering of the hydrogen-containing medium in the interior space, wherein the wall is in contact with the hydrogen-containing medium, and wherein in the interior space there is a pressure being at most equal to the upper limit, and a temperature of at most 100° C.;
supplying the hydrogen-containing medium from the hydrogen collector unit to the hydrogen processing unit,
   wherein:
the upper limit for the pressure is at most 50 bar, and
each of the one or more pipe elements is a casting, made from a nodular cast iron with a tensile strength of at most 600 MPa.

In other words, the invention relates to an apparatus suitable for a hydrogen application. A hydrogen application refers to an application or system in which use is made of a hydrogen-containing medium, for example in which a hydrogen-containing medium is processed, used, transported, stored, etc. In a possible embodiment, the apparatus is a hydrogen combustion engine. In other embodiments it relates to an installation in which hydrogen is processed or treated, for example a fuel cell, turbine, compressor, etc.

The apparatus comprises a hydrogen preparation unit, applied for supplying a hydrogen-containing gaseous medium. The hydrogen-containing medium is a gas or a gas mixture comprising at least 85% volume percent hydrogen. In one embodiment, the volume percentage of hydrogen present in the medium is for example 85%, 90% or 95%. The preparation unit serves as hydrogen supply, applied for supplying hydrogen-containing medium in the desired conditions. In particular, the preparation unit supplies the medium at a certain pressure. For example, the hydrogen preparation unit comprises one or more supply lines and one or more pressure controllers. The pressure delivered by the preparation unit may assume some other value, depending on the operating state of the apparatus. For example, if one or more pressure reducing valves or pressure regulating valves are present, with which the pressure is regulated to a set value or desired value, depending on the actual power. In an operating mode corresponding to a low power, hydrogen-containing medium is then delivered by the preparation unit at a set pressure that is lower than at nominal power. For example, an overpressure valve may also be present, with which, in case a pressure reducing valve is no longer working, the overpressure is discharged once a certain discharge value is reached. In this way, the pressure of the hydrogen-containing medium that is delivered by the preparation unit is always situated between a lower limit and an upper limit, depending on the current operating state. In other words, during operation of the apparatus, the hydrogen preparation unit provides feed of hydrogen-containing medium at a pressure that is at least equal to the lower limit, and at most is equal to the upper limit. For example, the upper limit for the pressure is realized when the overpressure valve comes into operation, in case the pressure reaches a certain discharge value. In that case hydrogen-containing medium is delivered by the hydrogen preparation unit at a pressure equal to the discharge value, wherein the latter corresponds to the upper limit that may occur. Depending on the current operating state, certain pressure levels are thus realized, varying between the lower and upper limit. In one embodiment it is possible that the lower limit and upper limit are equal to each other, so that during operation always the same pressure is delivered by the preparation unit.

The apparatus comprises a hydrogen collector unit. The collector unit is a component in which the hydrogen-containing medium may flow and/or may be buffered or stored temporarily. The collector unit is built up from one or more pipe elements, tubes or pipes. Together, these pipe elements define an interior space in which the medium is present. The interior space is delimited by an inside wall or a wall, which in the presence of the medium is in contact with the medium. In one implementation unit, the hydrogen collector unit corresponds to a gas rail, hydrogen rail or fuel rail, used in a hydrogen combustion engine. The hydrogen collector unit is connected to the hydrogen preparation unit, which means that the preparation unit and collector unit are in fluid communication, so that the medium delivered by the preparation unit ends up in the collector unit, via a direct connection or via one or more intermediate supply lines or pipelines.

The apparatus comprises a hydrogen processing unit, adapted for the processing and/or use of the hydrogen-containing medium. In one implementation unit, the hydrogen processing unit coincides with the combination of cylinders and injectors, such as are present in a hydrogen combustion engine. The hydrogen processing unit is connected to the hydrogen collector unit, which means that the collector unit and processing unit are in fluid communication, so that medium can flow from the collector unit to the processing unit, via a direct connection or via one or more intermediate supply lines or pipelines.

During operation of the apparatus, the hydrogen collector unit is fed with hydrogen-containing medium that is delivered by the hydrogen preparation unit. Furthermore, the hydrogen-containing medium is fed or distributed from the hydrogen collector unit to the hydrogen processing unit. During operation of the apparatus, the hydrogen-containing medium flows through the collector and/or is temporarily buffered or stored in the collector before being distributed to the processing unit. While the hydrogen-containing medium is in the collector unit, the inside wall of the collector unit is in contact with the hydrogen-containing medium. Inside the hydrogen collector unit there is hydrogen-containing medium at a temperature of at most 100° C. For example, the temperature is between −20° C. and 100° C., the hydrogen being gaseous. Inside the hydrogen collector unit there is hydrogen-containing medium at a certain pressure. This pressure is equal to the pressure of the medium that is delivered by the hydrogen preparation unit, for example achieved by means of an expansion system or pressure controllers. Consequently, during operation of the apparatus, a pressure prevails in the hydrogen collector unit which, depending on the operating state of the apparatus, is situated between the aforementioned lower limit and upper limit. The pressure level in the hydrogen collector unit is thus at most equal in value to the upper limit. All the stated pressure values, in bar, are values of overpressure or gauge pressure, measured relative to atmospheric pressure.

The upper limit for the pressure is at most 50 bar. For example, the upper limit is equal to 50 bar, which means that during operation of the apparatus, depending on the current operating state, the pressure delivered by the preparation unit and prevailing in the collector unit is situated between the lower limit and 50 bar, wherein the lower limit is less than or equal to 50 bar. In another embodiment the upper limit is equal to 10 bar, which means that during operation of the apparatus, depending on the current operating state, the aforementioned pressure is situated between the lower limit and 10 bar. For example, the lower limit is equal to 0.3 bar, so that the pressure in the collector unit may vary between 0.3 bar and 10 bar. In possible embodiments, the upper limit for the pressure is at most 50 bar and at least 5 bar. For example, the upper limit is equal to 5 bar, 10 bar, 20 bar, 30 bar, 40 bar or 50 bar.

The hydrogen collector unit is built up from one or more pipe elements. Each of these pipe elements is a casting, made from a nodular cast iron. Cast iron is an iron-carbon alloy, with a carbon content of typically more than 2% weight percentage. A casting is obtained by pouring cast iron in the liquid state into a mould, after which the material solidifies. The solidification rate, the presence of certain alloying elements, and any heat treatment applied, determine the final material structure and thus the final properties of the material. Nodular cast iron is a cast iron grade wherein free, unbound carbon is present in the form of nodules or spherical shapes in the solidified cast iron. In English this is referred to as “nodular cast iron”, “ductile cast iron”, “ductile iron”, “spheroidal graphite iron”, or “spheroidal graphite cast iron”. The matrix comprises ferrite and/or pearlite. Nodular cast iron refers to a group of materials, which differ from one another in material properties depending on their microstructure. For example, the microstructure of the matrix may be mainly ferritic or mainly pearlitic.

The hydrogen collector unit is built up from one or more castings, wherein each casting is made from a nodular cast iron with a tensile strength of at most 600 MPa or 600 N/mm². In one embodiment it relates to a nodular cast iron according to standard EN-GJS-400, with a tensile strength between 400 MPa and 500 MPa. In another embodiment it relates to a nodular cast iron according to standard EN-GJS-500, with a tensile strength between 500 MPa and 600 MPa.

This type of cast iron is generally a much used, common material, which offers advantages in terms of cost price and feasibility. In particular, parts can be cast easily in various shapes and dimensions, without the need for welding for making certain components. On the other hand, however, cast iron has a porous structure, so that in contact with hydrogen, easy diffusion of hydrogen into the porous structure of the material is generally expected, so that this material is very sensitive to hydrogen embrittlement. In the prior art it is thus advised against using porous material like this in combination with hydrogen, and instead make use of high-grade materials such as stainless steel and alloy steel grades, or use special coatings.

However, it was found, surprisingly, that despite the porous structure of the material, cast iron can be used in combination with hydrogen if certain conditions of pressure and temperature are met, and if a cast iron of a suitable type is selected. In fact, for cast irons in the group of nodular cast irons with a tensile strength of at most 600 MPa, it was found that, in conditions wherein the maximum temperature is 100° C. and the maximum pressure is 50 bar, there is very little hydrogen pickup, even in long-term exposure to almost pure hydrogen in the stationary state. Moreover, for this type of material in the stated hydrogen conditions, only a minimal effect was found in the plastic region, namely no reduction in tensile strength and only a small reduction in elongation.

Consequently, it becomes possible to employ said material for a hydrogen collector unit, in which the aforementioned conditions apply. For example, in a hydrogen combustion engine, wherein in the fuel rail typically almost pure hydrogen is present, at a temperature of at most 100° C. and a pressure of typically maximum 10 bar, use may be made of nodular cast iron for making the fuel rail. In fact, the invention allows the current stringent inspection requirements for such a component to be met, even though a common material such as cast iron is used. Inspection requires for example that at the highest pressure level that may possibly occur in the fuel rail, for example a pressure level of 10 bar, resistance to hydrogen embrittlement can be guaranteed, even if the pressure level in nominal operation is lower, for example at 3.5 bar. The resistance to hydrogen embrittlement should in addition be guaranteed in the case of almost permanent exposure to hydrogen in the stationary state, even if in practice there is only brief buffering and flow of hydrogen in the fuel rail.

To summarize, in the invention it was thus found, surprisingly, that despite the challenging application, with a substantial risk of hydrogen embrittlement through continuous exposure to almost pure hydrogen and the activation energy associated with the prevailing overpressure, it is nevertheless possible to use a common material.

This offers the advantage that the material cost of the hydrogen collector unit is substantially lower than when high-grade materials should be used. In addition, the use of cast iron contributes to good feasibility. In particular, the use of cast iron allows the collector to be cast thin-walled, so that despite the requirement of a double wall, nevertheless a compact design and simple integration of the collector in the engine are possible. Finally, the presence of welds in the collector unit is avoided, which contributes to improved robustness and durability.

Optionally, the upper limit for the pressure is at least 5 bar and at most 50 bar. In possible embodiments of apparatus, the pressure delivered by the hydrogen preparation unit, and prevailing in the hydrogen collector unit, is for example between the lower limit value and 5 bar, or between the lower limit value and 10 bar, or between the lower limit value and 20 bar, or between the lower limit value and 30 bar, or between the lower limit value and 40 bar, or between the lower limit value and 50 bar. This means that the hydrogen-containing medium present in the collector unit is always at a certain overpressure, or in any case operating states occur wherein said overpressure applies. An increased pressure is associated with imparting a certain activation energy to the hydrogen, which increases the risk of diffusion of hydrogen into the material of a wall. Despite this increased risk associated with the increased pressure, it was found, surprisingly, that a nodular cast iron can be used for the collector wall.

Optionally, the upper limit for the pressure is at least 9 bar, so that in possible embodiments the prevailing pressure in the collector unit is always greater than or equal to 9 bar.

Optionally, the upper limit for the pressure is equal to 10 bar, so that for an apparatus in this embodiment, the pressure prevailing in the hydrogen collector unit is between the lower limit value and 10 bar, depending on the operating state of the apparatus. For example, the lower limit value is 0.3 bar, and the pressure level in nominal operation is about 3.5 bar.

Optionally, the apparatus is a hydrogen combustion engine, in which
the hydrogen-containing gaseous medium functions as gaseous fuel, comprising at least 85 volume percent hydrogen;
the one or more pipe elements of said hydrogen collector unit, together form a fuel rail, and
the hydrogen processing unit comprises one or more injectors, and a combustion chamber per injector, and wherein the hydrogen combustion engine is adapted to, during operation,
temporarily buffer the hydrogen-containing medium in the fuel rail, at a temperature of at most 100° C., and at a pressure which, depending on the operating mode of the hydrogen combustion engine, is situated between the lower limit and the upper limit, and
distribute the hydrogen-containing medium from the fuel rail to the injectors, for combustion in the combustion chambers.

A hydrogen combustion engine is an internal combustion engine in which hydrogen, or a mixture comprising hydrogen, is used as fuel. Various types are possible, in various configurations. For example, it relates to a dual-fuel type, wherein the engine can operate both on diesel and on a mixture of hydrogen and diesel, and wherein in the hydrogen mode, diesel is used for igniting the hydrogen. In another embodiment it relates to an engine that can operate on hydrogen only, and wherein use is made of spark ignition or electrical ignition to initiate the igniting of the hydrogen.

In the hydrogen combustion engine, a fuel rail or gas rail is present, which serves as a hydrogen collector unit, and forms part of a hydrogen supply system. Typically, the hydrogen, or a hydrogen-containing gas mixture, is supplied from a storage tank, in which the gas is stored at high pressure, for example 200 bar minimum. Then, in the hydrogen preparation unit, for example comprising an expansion system or pressure controllers, the hydrogen-containing fuel is brought to the desired pressure, depending on the operating mode of the engine. Depending on the operating mode, the pressure delivered by the preparation unit varies between a lower limit and an upper limit, wherein the upper limit is at most 50 bar. For example, the delivered pressure is 3.5 bar in nominal operation of the engine, and the delivered pressure may be 10 bar maximum, wherein this last-mentioned value is realized when an overpressure valve comes into operation.

After the preparation unit, the hydrogen-containing fuel is collected in the fuel rail, where the hydrogen-containing fuel is buffered temporarily. Within the fuel rail, there is a temperature of at most 100° C. and a pressure equal to the pressure delivered by the hydrogen preparation unit. During the buffering and flow in the fuel rail, the hydrogen-containing fuel is in contact with the inside wall of the fuel rail. The fuel rail is built up from one or more pipe elements, wherein each pipe element is a casting, made from a nodular cast iron with a tensile strength of at most 600 MPa. From the fuel rail, the hydrogen-containing fuel is fed to the injectors, for example via one or more supply lines. The fuel rail thus serves for accumulation or temporary storage of the hydrogen-containing fuel, and distribution to the injectors.

Per injector, there is a combustion chamber, for example a cylinder, adapted to burn the fuel and thus provide drive. Typically, the hydrogen-containing fuel, which has a high hydrogen content, is mixed with air, just before the hydrogen-air mixture is drawn in via the inlet valve of the cylinder. The injectors and combustion chambers thus form part of a hydrogen processing unit, and achieve drive through the combustion of a fuel, as is known for a classical internal combustion engine. Ignition of the fuel may take place in various ways, for example through injection of diesel or by spark ignition.

Optionally, the nodular cast iron is of grade EN-GJS-400 or EN-GJS-450 or EN-GJS-500 according to European standard DIN EN 1563. Within the stated grades, there may be several variants, for example such as EN-GJS-400-15, EN-GJS-400-18-LT, EN-GJS-450-15, EN-GJS-450-10, etc. According to other norms or standards, other names may be used to refer to the same group of materials. For example, EN-GJS-400 is equivalent to GGG40 according to the older standard DIN 1693. Other equivalent grades of EN-GJS-400 are: ISO 1083 400-15, China GB1348 QT400-15, USA ASTM A536 60-40-18, Japan FCD400, Italy GS400-12, France FGS400-12, Spain FGE42-12, Belgium FNG42-12, Australia AS1831 400-12, Norway SJK-400. For a cast iron that comes under grade EN-GJS-400, the tensile strength is at least 400 MPa and at most 500 MPa. For a cast iron that comes under grade EN-GJS-500, the tensile strength is at least 500 MPa and at most 600 MPa. On the one hand, the cast iron should thus be nodular, not with flake graphite, and on the other hand the tensile strength should be low enough. Typically, cast irons of the stated grades are materials for which necking occurs under load prior to fracture.

Optionally, the nodular cast iron has a tensile strength between 400 MPa and 500 MPa. For example, the cast iron meets grade EN-GJS-400 according to European standard DIN EN 1563.

In one embodiment, the one or more castings are made from a ferritic or pearlitic nodular cast iron. For example it relates to a ferritic cast iron, with a predominantly ferritic microstructure, which means that the nodular cast iron consists of nodular graphite and a matrix, wherein in the matrix more ferrite is present than another structure such as pearlite. For example, the ferrite content in the cast iron is at least 75%, which means that the cast iron consists of graphite, ferrite and other components, and the percentage of ferrite by volume in the whole material is at least 75%. For example, the graphite content, in percentage by volume, is between 12% and 13%, the ferrite content is between 75% and 85%, and the pearlite content is between 2% and 10%. In another embodiment, in the casting process a pearlitic cast iron, with predominantly pearlitic matrix, is produced, and in this way a cast iron with the desired tensile strength, of at most 600 MPa, or situated between 400 and 500 MPa, is obtained. For example, the pearlite content in the cast iron is at least 55%, which means that the cast iron consists of graphite, pearlite and other components, and the percentage of pearlite by volume in the whole material is at least 55%. For example, the graphite content, in percentage by volume, is between 12% and 13%, the pearlite content is between 55% and 65%, and the ferrite content is between 20% and 35%.

Optionally, the hydrogen preparation unit is adapted for supplying the hydrogen-containing gaseous medium, at a pressure which, in the nominal operating state of the apparatus, is between 3 and 4 bar, for example 3.5 bar. For example, the apparatus is a hydrogen combustion engine, wherein at the nominal engine load the pressure in the gas rail is between 3 and 4 bar, for example is 3.5 bar.

Optionally, the lower limit for the pressure is at least 0.1 bar and at most 1 bar, for example 0.3 bar. The lower limit for the pressure is the lowest pressure value that occurs in the collector unit, for example in operation at low power. In a possible embodiment of the apparatus, the lower limit is equal to 0.3 bar, so that in the hydrogen collector unit, during operation of the apparatus there is always a pressure that is greater than or equal to 0.3 bar.

Optionally, each of the pipe elements is double-walled, wherein a pipe element comprises a second wall, placed around the first wall, and wherein said second wall is separated at least partially from the first wall by a cavity. The collector unit is thus made double-walled, wherein the first wall is in contact with the hydrogen-containing medium, and the second wall is separated from the first wall by an intermediate cavity. Optionally the two walls are joined together at one or more places over the perimeter or over the length, so that the two walls are not separated from each other completely, but an intermediate cavity is present over a substantial part. The double-walled configuration of the collector has the advantage that if there is a leak through the first wall, the second wall forms an extra barrier, so that hydrogen does not end up in the environment. This contributes to increased safety. In certain applications the double-walled configuration is a requirement imposed by an inspection standard.

Optionally, the pipe elements consist of tubing pieces and branch pieces, wherein:
each of the tubing pieces comprises a sleeve, wherein the sleeve has an end adapted to be connected to an adjacent tubing piece, so that tubing pieces linked together form a continuous tube, and wherein the tubing piece has a transverse opening made in the sleeve,
each of said branch pieces comprises a sleeve, wherein the sleeve has an end adapted to be connected to a tubing piece, at the position of the transverse opening, so that a branch is formed on the continuous tube.

The pipe elements thus comprise components of two types. A first type relates to a tubing piece, which typically extends in a longitudinal direction, and is open at one end or at both ends. The coupling together of several tubing pieces results in a continuous tube. A second type relates to a branch piece, for example configured as an elbow-shaped element. Each of the tubing pieces has a transverse opening, to which a branch piece may be connected. In this way, by assembling the tubing pieces and branch pieces, a continuous tube is formed, with one or more branches thereon. Typically, the continuous tube is supplied with hydrogen-containing medium, supplied by the hydrogen preparation unit, and the medium is distributed via the branches to the hydrogen processing unit. For example, each branch piece forms a supply to an injector and the associated cylinder.

Optionally the hydrogen preparation unit comprises an expansion system placed between a high-pressure line and a low-pressure line and comprising one or more pressure controllers, wherein the expansion system is adapted to reduce the pressure of the hydrogen-containing medium delivered via the high-pressure line to a pressure between the lower limit and the upper limit in the low-pressure line, wherein the low-pressure line is connected to the hydrogen collector unit. The hydrogen preparation unit thus comprises a high-pressure line, an expansion system, and a low-pressure line. In one embodiment, the high-pressure line of the apparatus is supplied directly from a hydrogen mains, at a defined supply pressure. In another embodiment the apparatus comprises a tank, connected to the high-pressure line, for storage of the hydrogen-containing medium at a pressure above 50 bar. Typically the gaseous hydrogen-containing medium is stored in a tank at high pressure, for example 200 bar, 350 bar, 500 bar or 700 bar. For example, hydrogen-containing medium is delivered from the tank via a high-pressure line, for example a high-pressure fuel line. The expansion system comprises one or more pressure controllers, for example pressure regulating valves and an overpressure valve, with which the pressure of the medium delivered via the high-pressure line is reduced to a lower level. The resultant lower pressure level then depends on the actual state of the apparatus, and varies for example between 0.3 bar and 50 bar, or between 0.3 bar and 10 bar. The low-pressure line, connected to the expansion system, allows the hydrogen-containing medium to be supplied at the lower pressure level to the hydrogen collector unit. For example, the tank, high-pressure line, expansion system, low-pressure line and hydrogen collector unit together form a hydrogen supply system, adapted for supplying hydrogen-containing medium in the appropriate conditions to the hydrogen processing unit.

Optionally the one or more pressure controllers comprise one or more pressure regulating valves, adapted to reduce the pressure of the hydrogen-containing medium delivered via the high-pressure line, to a set value situated between the lower limit and the upper limit. For example, one or more pressure regulating valves or pressure reducing valves are present which, depending on the actual power, reduce the pressure to a certain desired value or set pressure between 0.3 bar and 3.5 bar. Optionally, the pressure controllers comprise one or more overpressure valves, adapted to reduce the pressure of the hydrogen-containing medium delivered via the high-pressure line, to a discharge value equal to the upper limit. This means that an overpressure valve is present, which is set to a certain discharge value; if the overpressure valve comes into operation, for example because a pressure regulating valve is defective, the overpressure is discharged up to the discharge value, and the pressure in the hydrogen collector unit is also at this discharge value. The discharge value to which the overpressure valve is set thus coincides with the aforementioned upper limit value for the pressure.

Optionally, the apparatus is a hydrogen combustion engine with a power of at least 500 kW. It thus relates to engines of high power, for example suitable for shipping, railway traffic and power stations. In various embodiments, it relates for example to hydrogen combustion engines with 6, 8, 12 or 16 cylinders and a power between 1000 kW and 3000 kW.

According to a second aspect of the present invention, the aims identified above are achieved by the use of a hydrogen collector unit, wherein said use comprises:
providing a hydrogen collector unit comprising one or more pipe elements which together define an interior space delimited by a wall;
providing a hydrogen-containing gaseous medium, with at least 85 volume percent hydrogen;
causing the hydrogen-containing medium to flow and/or temporarily buffering the hydrogen-containing medium and/or storing the hydrogen-containing medium in the interior space, at a temperature of at most 100° C. and at a pressure situated between a lower limit and an upper limit, wherein said wall is in contact with said hydrogen-containing medium, and wherein the lower limit is less than or equal to the upper limit;
   and wherein:
the upper limit for said pressure is at most 50 bar, and
each of said one or more pipe elements is a casting, made from a nodular cast iron with a tensile strength of at most 600 MPa.

It thus relates to the use of a hydrogen collector unit, wherein during use, a gaseous hydrogen-containing medium, comprising at least 85% volume percent hydrogen, is present. The medium is buffered or stored in the collector, and/or the medium flows through the collector. In one embodiment, the hydrogen collector unit is a fuel rail or gas rail in an internal combustion engine. In another embodiment, the hydrogen collector unit is a storage tank, in which the hydrogen-containing medium is stored. During use of the hydrogen collector unit, the pressure of the hydrogen-containing gaseous medium is at a value that is situated between a lower limit and an upper limit. In one embodiment, the pressure in the collector varies depending on a particular operating state. In another embodiment, the lower limit is equal to the upper limit and the same pressure prevails while the medium is in the collector. The upper limit of the pressure prevailing in the hydrogen collector unit is at most 50 bar. In one embodiment, the upper limit for the pressure is at least 5 bar and at most 50 bar, for example the upper limit is 10 bar. The hydrogen collector unit is built up from one or more pipe elements, which together define an interior space delimited by a wall. A pipe element may then have two open ends, or one open and one closed end, or it may be closed at both ends.

Optionally, the use comprises:
providing a hydrogen preparation unit, in communication with said hydrogen collector unit;
providing a hydrogen processing unit, in communication with said hydrogen preparation unit;
supplying the hydrogen-containing medium by the hydrogen preparation unit, at a pressure which, depending on the operating state of the apparatus, varies between the lower limit and the upper limit;
feeding the hydrogen collector unit with the hydrogen-containing medium, from the hydrogen preparation unit, wherein the hydrogen-containing medium flows in and/or is buffered temporarily in the interior space;
supplying the hydrogen-containing medium from the hydrogen collector unit to the hydrogen processing unit;
processing and/or using the hydrogen-containing medium in the hydrogen processing unit.
   Thus, the hydrogen collector unit is used in an apparatus for a hydrogen application, wherein the apparatus is defined according to the first aspect of the invention.

Optionally, the hydrogen collector unit is a fuel rail, used in a hydrogen combustion engine, wherein
the hydrogen-containing medium functions as fuel, comprising at least 85 volume percent hydrogen;
the hydrogen processing unit comprises one or more injectors, and a combustion chamber per injector, and wherein the use comprises:
temporary buffering of the hydrogen-containing medium in the fuel rail, at a temperature of at most 100° C. and at a pressure which, depending on the operating mode of the hydrogen combustion engine, varies between the lower limit and the upper limit;
distributing the hydrogen-containing medium from the fuel rail to the injectors;
burning the hydrogen-containing medium in the combustion chambers.
   Thus, the hydrogen collector unit is a fuel rail or gas rail, used in a hydrogen combustion engine.

### BRIEF DESCRIPTION OF THE DRAWINGS

FIG. 1 is a schematic illustration of an apparatus suitable for a hydrogen application, according to an embodiment of the invention.

FIG. 2, FIG. 3, FIG. 4 and FIG. 5 show a hydrogen combustion engine, according to an embodiment of the invention. FIG. 2 and FIG. 3 each give a three-dimensional view, wherein in FIG. 3, an exhaust bank has been removed from the diagram to make internal components visible. FIG. 4 and FIG. 5 give a front view and a rear view, respectively.

FIG. 6 and FIG. 7 give, respectively, a three-dimensional view and a cross-section of a tubing piece, according to an embodiment of the invention.

FIG. 8 and FIG. 9 give, respectively, a three-dimensional view and a cross-section of a branch piece, according to an embodiment of the invention.

FIG. 10 gives a three-dimensional view of a branch piece connected to a tubing piece, according to an embodiment of the invention.

### DETAILED DESCRIPTION OF THE EMBODIMENTS

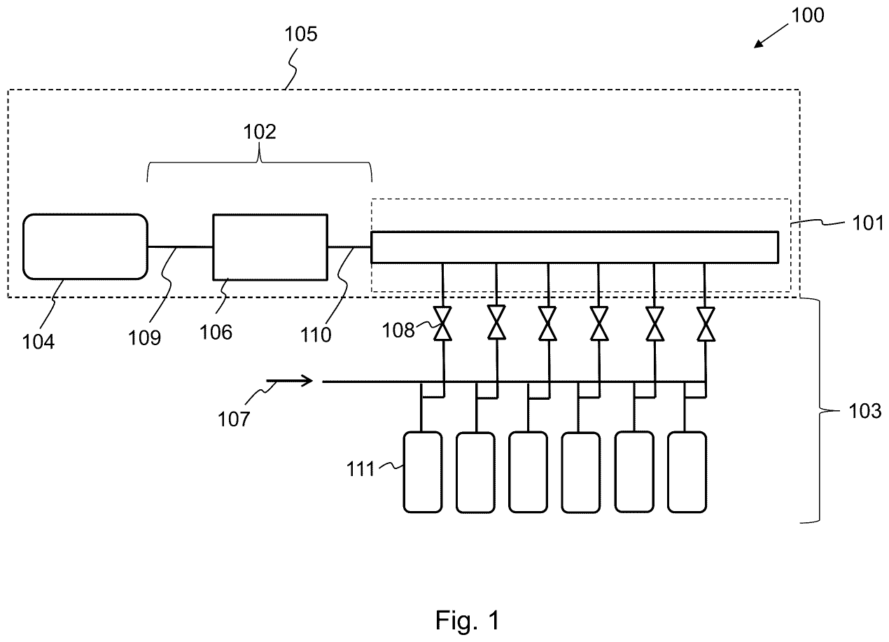

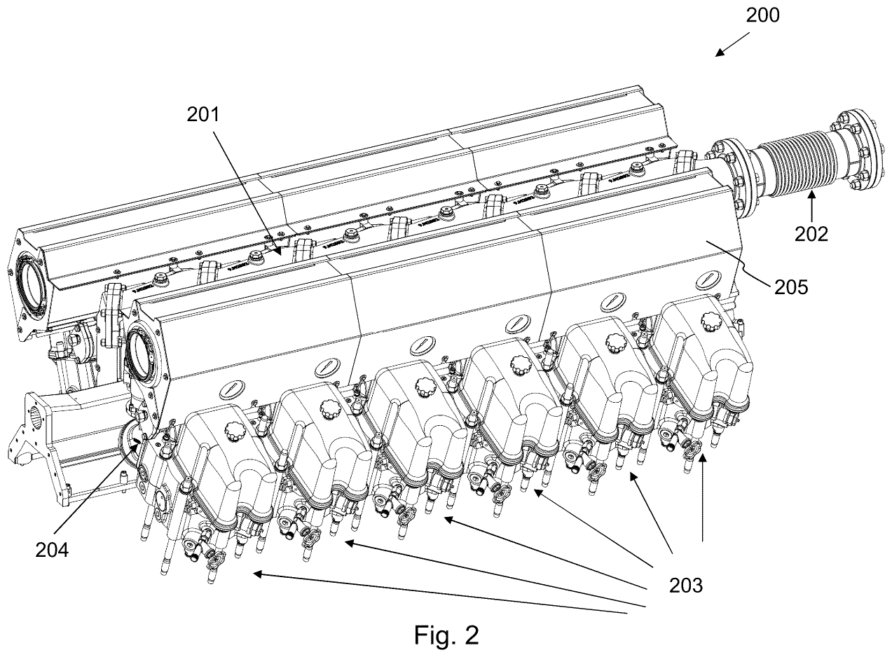

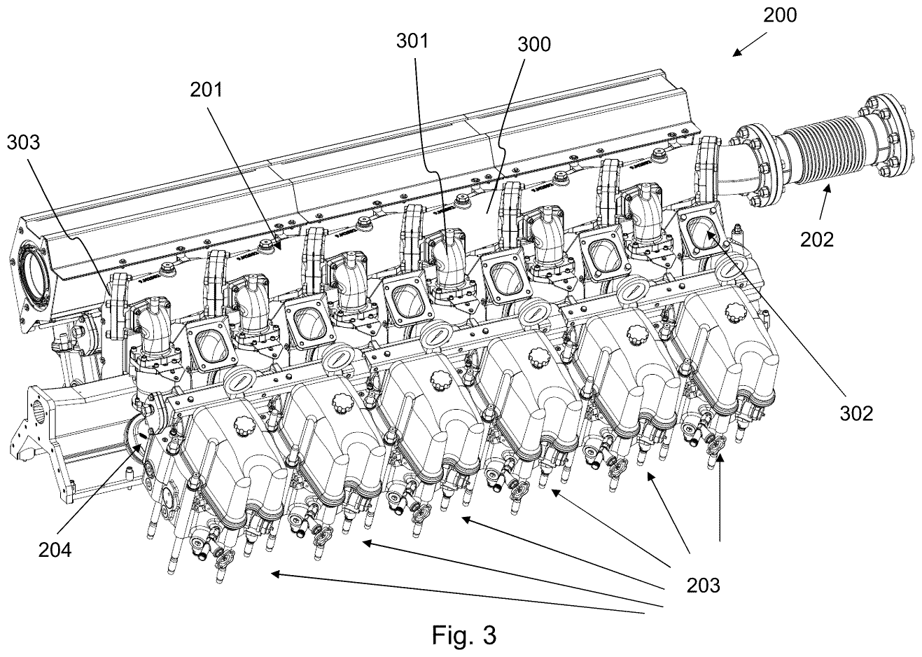

FIG. 1 illustrates schematically an apparatus 100 suitable for a hydrogen application, according to an embodiment of the invention. For example, the apparatus 100 is a hydrogen combustion engine 200, which is further illustrated in FIGS. 2-5. The apparatus 100 comprises a hydrogen preparation unit 102, a hydrogen collector unit 101, and a hydrogen processing unit 103. The hydrogen preparation unit 102 comprises a high-pressure line 109, an expansion system 106 and a low-pressure line 110. The high-pressure line 109 is connected to a tank 104. The low-pressure line 110 is connected to the hydrogen collector unit 101. A gaseous hydrogen-containing medium, comprising at least 85% volume percent hydrogen, is stored in the tank 104. Storage in the tank typically takes place at a high pressure, for example 200 bar, 350 bar, 500 bar or 700 bar. The expansion system 106 comprises pressure controllers, so that the pressure of the hydrogen-containing medium is reduced to a lower value in the low-pressure line 110. The pressure reached in the low-pressure line 110 depends on the operating state of the apparatus 100, and is always situated between a lower limit and an upper limit. The upper limit is 50 bar or lower, for example 10 bar. The hydrogen-containing medium is fed, at the lower pressure achieved, via the low-pressure line 110 to the hydrogen collector unit 101.

In the collector unit 101, the medium is temporarily buffered, and distributed to the hydrogen processing unit 103. The tank 104, the high-pressure line 109, the expansion system 106, the low-pressure line 110, and the hydrogen collector unit 101 together form a hydrogen supply system 105, adapted for supplying hydrogen-containing medium in the appropriate conditions to the hydrogen processing unit 103. The hydrogen-containing medium is processed or used in the hydrogen processing unit 103. In the embodiment shown, the hydrogen-containing medium is used in cylinders 111 of an internal combustion engine. Hydrogen-containing medium is fed to the cylinders 111 of the engine via gas admission valves (gas injectors) 108. Prior to admission into the cylinders 111, the hydrogen-containing medium is mixed with air 107.

FIGS. 2-5 show a hydrogen combustion engine 200. The embodiment shown relates to an engine with 12 cylinders in V configuration, with a power up to 2000 kW, typically used for propulsion of large ships or trains.

The hydrogen combustion engine 200 comprises a fuel rail 201 or gas rail 201, which corresponds to the hydrogen collector unit 101 from FIG. 1. A gaseous, hydrogen-containing fuel is fed from a low-pressure fuel line 202 to the gas rail 201. The gaseous fuel comprises at least 85% volume percent hydrogen, and may in possible embodiments comprise 90% or 95% hydrogen, so that it is almost pure hydrogen. The low-pressure fuel line 202 forms part of a hydrogen preparation unit, not shown in FIGS. 2-5. For this purpose, the hydrogen preparation unit 102 comprises, similarly to FIG. 1, a high-pressure fuel line 109 and pressure controllers 106. Also similarly to FIG. 1, the fuel is stored at high pressure in a tank 104, not shown in FIGS. 2-5.

By means of the pressure controllers 106, the hydrogen-containing fuel is brought to the lower pressure level, depending on the operating state of the hydrogen engine 200. In the embodiment shown, the pressure controllers 106 comprise at least one pressure regulating valve or pressure reducing valve. On the basis of said valve, a desired value or set value of the pressure is achieved, depending on the actual engine power. This desired pressure level is about 3.5 bar in nominal operation, and 0.3 bar at low power. In the preparation unit there is also at least one overpressure valve, which comes into operation when, for example through a fault in a pressure regulating valve, the pressure is no longer reduced as desired. The overpressure valve is set at a discharge value of 10 bar, so that the maximum pressure value that can occur after the pressure controllers 106 is 10 bar. Consequently, the pressure of the gaseous fuel delivered via the low-pressure fuel line 202 is always situated between 0.3 bar and 10 bar. This is also the pressure prevailing in the fuel rail 201. The temperature in the fuel rail 201 is typically not much higher than ambient temperature, and is at most 100° C.

In FIG. 3, for clarity the exhaust bank 205 has been omitted. As can be seen in FIG. 3, the fuel rail 201 is built up from several pipe elements 300, 301. The pipe elements are of two different types, namely tubing pieces 300 and branch pieces 301. The tubing pieces 300 linked together form a continuous tube. The continuous tube is connected at one end to the low-pressure fuel line 202 and at the other end is closed by means of an end plate 303. In addition, a branch piece 301, for supply of hydrogen to one of the cylinders, is fastened to each tubing piece 300.

The pipe elements 300, 301 define together an interior space, in which the gaseous fuel can flow and can be buffered temporarily. The interior space is delimited by a wall, whose internal surface is in contact with the hydrogen-containing fuel. Consequently, the inside wall of the fuel rail 201 is continuously in contact with almost pure hydrogen, so that there is a substantial risk of diffusion of hydrogen into the material of the wall, if a hydrogen-compatible material is not used for the wall. This risk is further increased by the pressure present in the fuel rail 201, wherein inspection requires that at the highest pressure level that can occur, in this case 10 bar, resistance to hydrogen embrittlement is guaranteed.

From the gas rail 201, the hydrogen is fed to the 12 injectors, wherein one injector is present per cylinder, as indicated as 203 in FIGS. 2 and 3. Prior to admission into a cylinder 203, the hydrogen is mixed with air, which is supplied via line 204. This is further illustrated in front view in FIG. 4, in which the hydrogen flow is represented schematically as 400, and the air stream as 401. The hydrogen-air mixture 402 is drawn into the cylinder, and then compressed and ignited. In various embodiments, ignition may take place differently. In the case of a dual fuel engine, ignition takes place by injection of a pilot fuel, for example 15% diesel. In the case of a spark ignited engine, use is made of spark ignition. For both embodiments, the situation in the fuel rail is similar, in the sense that almost pure hydrogen is buffered there at a pressure of at most 10 bar. After ignition, the hydrogen present in the cylinder is burnt, resulting in the drive stroke. Exhaust gases then leave the cylinder via line 302, shown in FIG. 3.

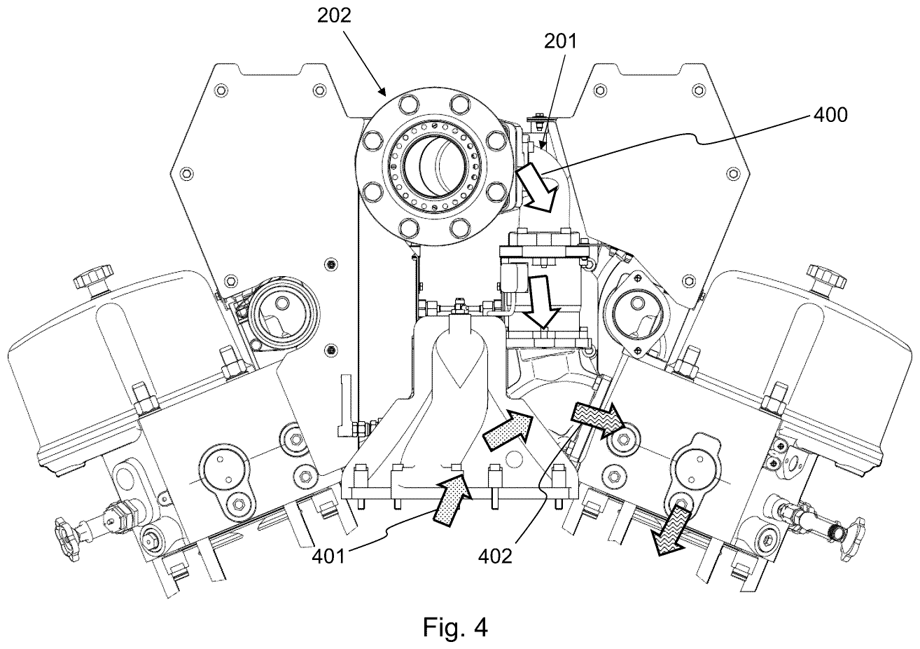

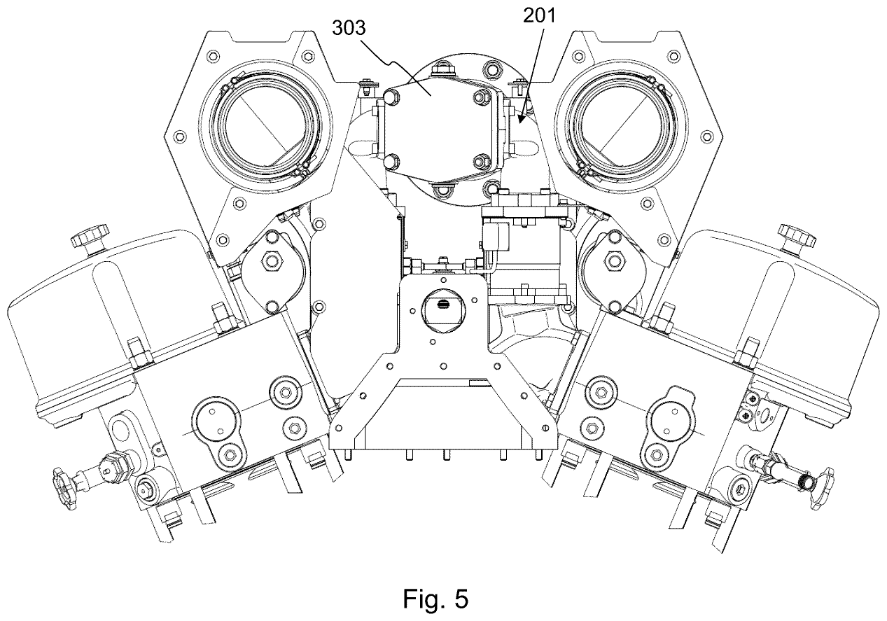

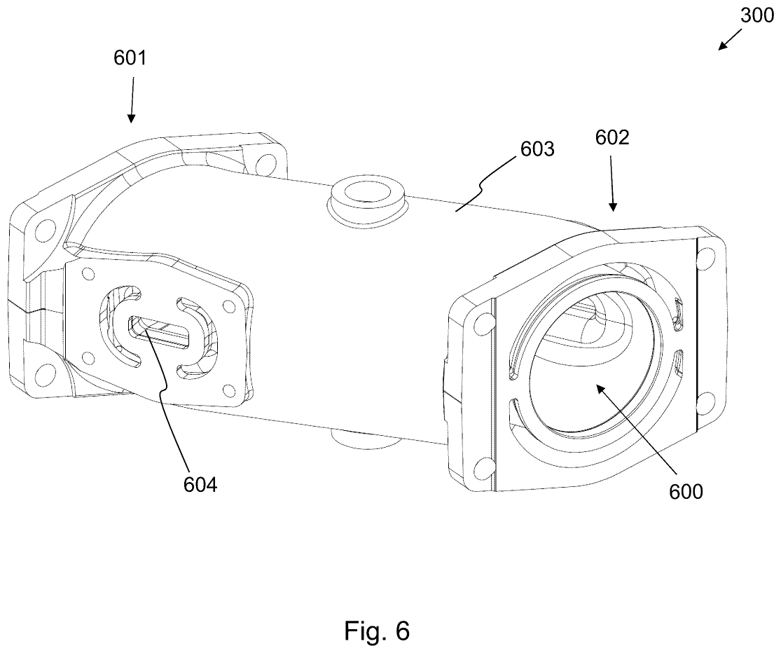

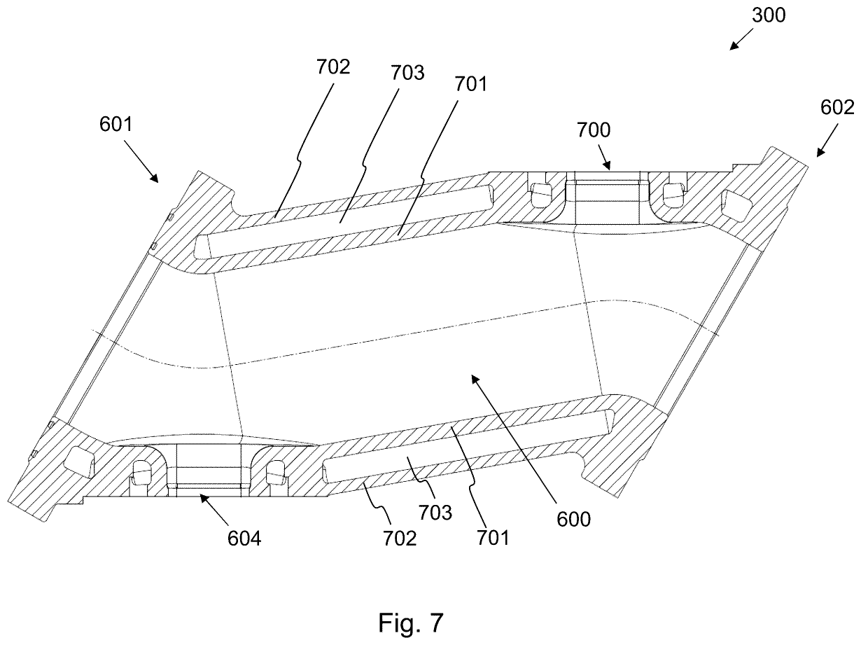

FIG. 6 and FIG. 7 show a tubing piece 300. The tubing piece 300 is made double-walled, wherein a first wall 701 delimits an interior space 600. The internal surface of the first wall 701 is in contact with the hydrogen-containing fuel. A second wall 702 is placed around the first wall 701, and there is a cavity 703 between the two walls 701, 702. The tubing piece 300 further comprises a sleeve 603, with open ends 601 and 602. The ends 601 and 602 are adapted to be connected to another tubing piece 300. A cover plate 303 may also be placed on an end 601, 602. In the sleeve 603, there is a transverse opening 604, and a transverse opening 700.

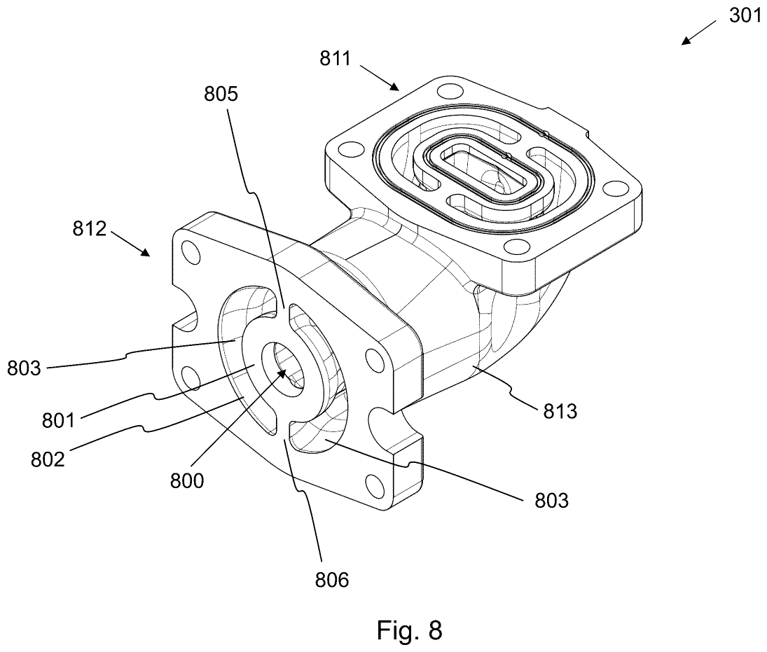

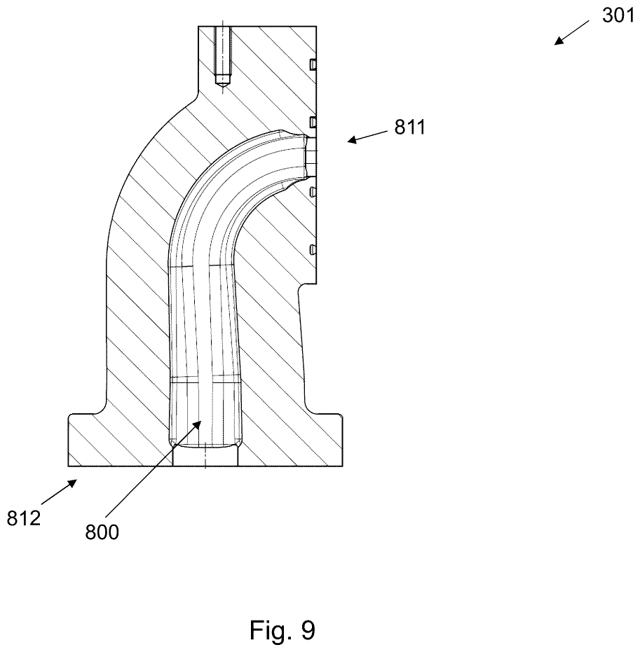

FIG. 8 and FIG. 9 show a branch piece 301, configured as an elbow. The branch piece 301 is made double-walled, wherein a first wall 801 delimits an interior space 800. The internal surface of the first wall 801 is in contact with the hydrogen-containing fuel. A second wall 802 is placed around the first wall 801, and a cavity 803 is located between the two walls 801, 802. The two walls 811, 812 are joined together in two places 805, 806. The branch piece 301 further comprises a sleeve 813, with open ends 811 and 812. The end 811 is adapted to be connected to a tubing piece 300.

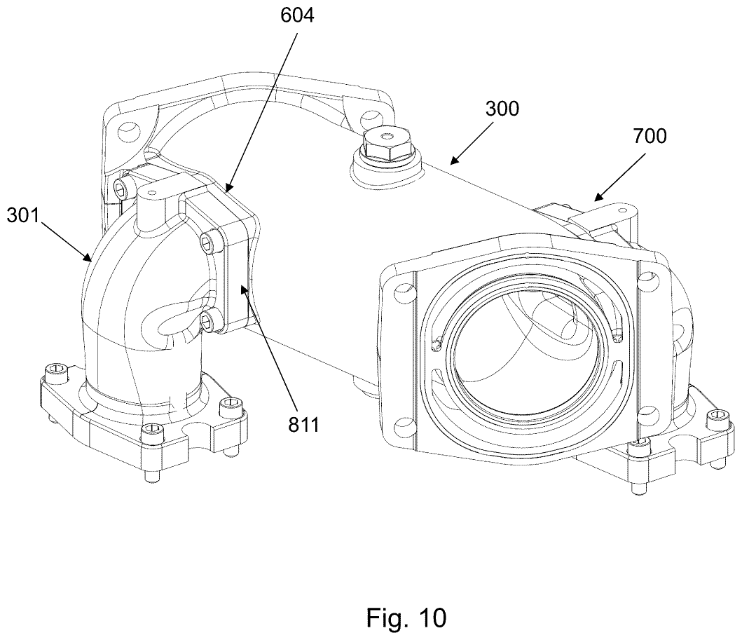

Several tubing pieces 300 linked together form a continuous tube, as shown in FIG. 3, in which hydrogen is supplied. FIG. 10 shows how a branch piece 301 is connected to a tubing piece 300, at the position of the transverse opening 604. In this way, hydrogen can be fed from the tubing piece to a cylinder from the first line of six cylinders. Similarly, a branch piece 301 may be connected to the other transverse opening 700, for supply to a cylinder from the second line of six cylinders.

The double-walled configuration of the pipe elements 300, 301 is necessary because of safety requirements. On the other hand, a compact design of the fuel rail 201 is also necessary, to allow simple integration thereof in the engine 200. In particular, the distances between two cylinder heads, determined by the V-angle of the engine, form a limitation: the inlet collector/exhaust collector must also be placed in this space between the two cylinder heads between the two banks. In order to allow this compact design of the gas rail 201 despite the double wall, sufficiently thin walls should be provided for the pipe elements 300, 301. In the embodiment shown, this is achieved by thin-walled casting: each of the tubing pieces 300 and branch pieces 301 is made as a casting, and is made from cast iron. In view of the risk of diffusion of hydrogen into the wall of the gas rail 201, in addition a material should be selected which, in the prevailing conditions of pressure and temperature, offers sufficient resistance to hydrogen embrittlement. In the invention, a nodular cast iron is therefore selected, with a tensile strength of at most 600 MPa.

In particular, in the embodiment shown, each of the pipe elements 300, 301 is made of a nodular cast iron that meets grade EN-GJS-400-15. Typical properties of this material are:
yield point: min. 250 MPa; tensile strength: min. 400 MPa; elongation: min. 15%. A typical stress-strain curve, measured in air, shows necking prior to fracture.
density: 7.3 g/cm³, Brinell hardness: 130-180.
typical chemical composition: C: 2.5-3.8%; Si: 0.5-2.5%; Mn: 0.2-0.5%; P: ≤0.08%; S: ≤0.02%.

To arrive at the surprising finding that the aforementioned cast irons are sufficiently resistant to hydrogen embrittlement, and thus allow use in a fuel rail of a hydrogen combustion engine, experimental research was carried out by the inventors. This experimental research relates to a first and a second series of tests.

In a first test series, various materials were investigated for their compatibility with hydrogen. In particular, materials in the following grades were investigated: EN-GJS-400-15, EN-GJS-700, Mk11C and RVS316. The last-mentioned grade of material relates to a stainless steel grade with austenitic microstructure, and was included in the research as a reference material that is compatible with hydrogen environments. The first three material grades relate to cast irons, for which microstructural analysis was performed on test specimens of 5×8×50 mm. The following microstructure was found for the cast irons investigated:
EN-GJS-400-15: nodular graphite (13%), ferrite (77%), pearlite (10%). This therefore relates to a predominantly ferritic nodular cast iron. Most of the graphite particles have a size between 60 μm and 120 μm; some smaller particles, from 15 μm to 30 μm, were also found. For density, a total particle density of 126 graphite particles per mm² was found, including 73 particles/mm² nodular particles. Ti-rich inclusions were found in this material.
EN-GJS-700: nodular graphite (13%), ferrite (1%), pearlite (86%). This therefore relates to a predominantly pearlitic nodular cast iron, with a tensile strength of at least 700 MPa. Most of the graphite particles have a size between 15 μm and 30 μm; only a few smaller particles were found. For density, a total particle density of 171 graphite particles per mm² was found, including 150 particles/mm² nodular particles. Mainly Mg-oxides were found as inclusions.
Mk11C: flake graphite (12%), pearlite (88%). This therefore relates to a flake graphite cast iron. 34% of the graphite particles have a size between 30 μm and 60 μm, and 33% of the graphite particles have a size between 60 μm and 120 μm. Some smaller graphite particles were also found. For density, a total particle density of 1026 graphite particles per mm² was found. Presence of MnS was detected, as well as Mo-rich particles.

Per grade of material, in each case a number of test specimens were exposed to hydrogen for 1000 hours, at room temperature and a pressure of 10 bar. The pressure level of 10 bar was selected since this is the design pressure in the proposed hydrogen combustion engine, i.e. the maximum pressure that can occur in the gas rail. The test specimens were not loaded during exposure to hydrogen. Per grade of material, a number of test specimens were also provided which were not exposed to hydrogen.

After exposure to hydrogen, in a first evaluation test it was established which test specimens exhibited hydrogen pickup. For this purpose, measurements were performed per grade of material on two test specimens of 5×8×50 mm, wherein one test specimen was exposed to hydrogen and the other was not. The hydrogen concentration was determined based on melt extracts in a G8 GALILEO (Brüker).

The measurements are summarized in the following table (Table 1). It can be seen that the materials EN-GJS-700 (pearlitic nodular cast iron, tensile strength min. 700 MPa) and Mk11C (flake graphite cast iron) display definite hydrogen pickup; both materials pick up about 0.3 ppm hydrogen. This sensitivity to hydrogen pickup is in line with the teaching in the prior art that generally cast iron is sensitive to hydrogen pickup. For RVS316 (stainless steel) it was established that no significant hydrogen pickup occurred; the differences measured between the exposed and unexposed test pieces are within the standard deviation of the measurements. This result too is in line with the expectations, since good resistance of stainless steel to hydrogen pickup is generally assumed. Surprisingly, however, the material EN-GJS-400-15 (ferritic nodular cast iron, tensile strength min. 400 MPa) is also found to display hardly any hydrogen pickup, despite the fact that this is a cast iron with a porous structure.

TABLE 1

| | Average hydrogen concentration (ppmw) | |
|---|---|---|
| | After 1000 hours exposure | Without exposure to |
| | to hydrogen at 10 bar | hydrogen |
| EN-GJS-400-15 | 1.20 ± 0.13 | 1.36 ± 0.05 |
| EN-GJS-700 | 1.54 ± 0.16 | 1.19 ± 0.08 |
| Mk11C | 1.31 ± 0.10 | 0.99 ± 0.04 |
| RVS316 | 1.04 ± 0.06 | 0.96 ± 0.07 |

In a further evaluation in the first test series, tensile tests were carried out on test specimens exposed to hydrogen, and the results were compared against an identical tensile test carried out on test specimens that had not been exposed to hydrogen. In this case round tensile specimens were used and they were tested according to standard NBN EN ISO 6892-1 method B.
In this case, test specimens of RVS316 (stainless steel) that were exposed to hydrogen exhibited similar behaviour to the test specimens that were not exposed to hydrogen. RVS316 therefore seems not to be sensitive to hydrogen embrittlement, which is in line with expectations.
Test specimens of materials EN-GJS-700 (pearlitic nodular cast iron, tensile strength min. 700 MPa) and Mk11C (flake graphite cast iron), which were exposed to hydrogen, displayed a clear loss of mechanical properties compared to a test specimen from the same material that was not exposed to hydrogen: premature breakage, with brittle fracture, was established for the test specimens exposed to hydrogen. For example, for a test specimen of Mk11C, exposed to hydrogen, an Rm value and elongation at rupture were measured of 271 MPa and 0.16% respectively, whereas for a test specimen without exposure to hydrogen the values were 291 MPa and 0.29% respectively. For example, for a test specimen of EN-GJS-700, exposed to hydrogen, an Rm value and elongation at rupture were measured of 617 MPa and 1.5% respectively, whereas for a test specimen without exposure to hydrogen the values were 696 MPa and 3.1% respectively. Both cast irons are therefore clearly susceptible to hydrogen embrittlement, which is in line with the general teaching in the prior art regarding cast iron in combination with hydrogen.
Finally, for test specimens of material EN-GJS-400-15 (ferritic nodular cast iron, tensile strength min. 400 MPa) that were exposed to hydrogen, no loss of mechanical properties was established compared to a test specimen of the same material that was not exposed to hydrogen: no premature rupture occurs as a result of exposure to hydrogen, and ductile fracture was found for the test specimens after maximum loading. Contrary to what was expected on the basis of the teaching in the prior art, this cast iron does not appear to be susceptible to hydrogen embrittlement, in the stated test conditions.

In a second test series, first the material EN-GJS-400-15 was further validated for its hydrogen compatibility. For this purpose use was made of EN ISO 11114-4 method A breaking test, more specifically the “disc burst test”. This test allows an “embrittlement index (EI)” to be calculated. An EI value equal to 2 or lower indicates a material suitable for cylinders with compressed hydrogen. Tests were carried out using helium and hydrogen as test gas, at an applied pressure increase of 10 bar/min. The test specimens are discs with a diameter of 58 mm and thickness of 2 mm. Under helium the burst pressure was 605 bar (pR_He), under hydrogen it was 485 bar (pR_H2). After applying a thickness correction factor, as described in standard EN ISO 11114-4, p′R_He and p′R_H2 were calculated, from which the value for the EI index then follows (EI=p′R_He/p′R_H2). For the measured test specimens of EN-GJS-400-15 material, an EI value of 1.2 was obtained, so that the material can be considered to be hydrogen-compatible. The disc rupture test was also repeated on test specimens of EN-GJS-400-15 material with an applied pressure increase of 1.5 bar/min. Similar results were obtained, namely an EI value between 1.2 and 1.3.

In the foregoing tests, use was made of EN-GJS-400-15 material with a predominantly ferritic structure, for example 77% or 82% ferrite for various test specimens. A nodular cast iron with an identical tensile strength level, between 400 and 500 MPa, can also be produced by a suitable casting process, so that a predominantly pearlitic structure is obtained. Similar tests were carried out on an EN-GJS-400 material with predominantly pearlitic structure, namely 12% graphite, 61% pearlite and 27% ferrite. On the basis of the tests carried out, this material was also found to be hydrogen-compatible.

Finally, a third test series was carried out, in which the influence of pressure on the development of hydrogen embrittlement was investigated further. In this case, tensile tests were used, more specifically a “slow strain rate test” (SSRT), carried out in air, and in a hydrogen atmosphere at 10 bar and at 50 bar. The SSRT test was carried out at a constant rate of deformation ds/dt=0.018 mm/min, corresponding to a rate of elongation of 0.036%/min. Several test specimens were tested, all made of a cast iron of grade EN-GJS-400-15. For these test specimens the graphite content is between 12% and 13%, the ferrite content between 83% and 85%, and the pearlite content between 2% and 5%.

During execution of an SSRT test, the stress-extension curve was measured and on completion the mechanical properties were determined. The results are summarized in the following table (Table 2).

TABLE 2

| | | | Epsilon_{—} | Sigma_{—} | | | Break |
|---|---|---|---|---|---|---|---|
| | E | A | break | break | Rp0.2 | Rm | necking |
| Test | [GPa] | [%] | [%] | [MPa] | [MPa] | [MPa] | [%] |
| (1) Air | 143 | 15.09 | 15.36 | 393 | 310 | 443 | 13.62 |
| (2) Air | 140 | 9.37 | 9.62 | 358 | 314 | 431 | 11.79 |
| (3) H2 | 150 | 13.05 | 13.29 | 355 | 299 | 429 | 10.41 |
| 10 bar | | | | | | | |
| (4) H2 | 148 | 11.47 | 11.71 | 357 | 293 | 422 | 11.18 |
| 10 bar | | | | | | | |
| (5) H2 | 149 | 11.78 | 12.02 | 350 | 298 | 426 | 12.20 |
| 10 bar | | | | | | | |
| (6) H2 | 168 | 10.29 | 10.49 | 341 | 300 | 427 | 9.14 |
| 50 bar | | | | | | | |

In test (1), carried out in air, the highest elongation at rupture (Epsilon_break) and necking were measured, demonstrating the high plasticity of the material. Test (2), also carried out in air, shows a lower elongation at rupture compared to test (1), which confirms that for cast material there may be scatter of material properties. Tests (3), (4) and (5) were carried out in hydrogen, at a pressure of 10 bar. In each case a tensile strength (Rm, ultimate tensile strength) was measured of more than 420 MPa, and an elongation at rupture of more than 10%. The material thus does not seem to exhibit brittle behaviour in a hydrogen atmosphere at 10 bar. Test (6) was carried out in hydrogen, at a pressure of 50 bar. The measured values for elongation at rupture and necking at break are lower than in the tests at 10 bar. This shows that hydrogen embrittlement increases with increasing hydrogen pressure, but not to the extent that in test (6) a completely brittle behaviour is observed. The pressure value of 50 bar may consequently be regarded as an upper limit for the permissible pressure at which material EN-GJS-400-15 may still be used in combination with hydrogen. This is also confirmed from the shape of the measured tension-extension curve for test (6), wherein in the plastic portion a perfectly continuous curve was not measured, but the curve has a discontinuous course at three time points, with a sudden decrease in tension at almost identical extension, before fracture occurs.

Finally, the fracture surface for the various test specimens was investigated by fractography. For the test at 50 bar, larger zones of brittle fracture were found on the fracture surface than in the tests at 10 bar, and in the tests in air, no zones of brittle fracture were observed on the fracture surfaces.

On the basis of the test series that were carried out, the inventors came to realize that a flake graphite cast iron is not suitable for use in combination with hydrogen, just like a nodular cast iron with high tensile strength, namely higher than 600 MPa. Typically these unsuitable cast irons are materials for which, in air, without being exposed to hydrogen, necking does not occur prior to fracture. In contrast, nodular cast irons with a sufficiently low tensile strength, namely at most 600 MPa, appear to be suitable for use in combination with hydrogen, in the conditions present in the hydrogen collector. Both nodular cast irons with predominantly ferritic structure and with predominantly pearlitic structure come into consideration, if the tensile strength is not above 600 MPa. These nodular cast irons seem to be suitable for use in combination with hydrogen, despite their porous structure and the general advice in the prior art not to use cast irons in combination with hydrogen. A possible explanation for these nodular cast irons with sufficiently low tensile strength being suitable is that hydrogen that may collect in the cavities round the carbides reduces the ductility of the material considerably and gives rise to the development of a more brittle fracture. However, in nodular cast iron with sufficiently low tensile strength, the matrix around the carbides is able to compensate for this reduction in ductility caused by hydrogen without an appreciable reduction in tensile strength, and thus effectively avoid occurrence of brittle fracture.

Although the present invention has been illustrated on the basis of specific embodiments, for a person skilled in the art it will be clear that the invention is not limited to the details of the foregoing illustrative embodiments, and that the present invention may be carried out with various modifications and adjustments while remaining within the scope of the invention. The present embodiments must therefore be considered in all respects as illustrative and not restrictive, the field of application of the invention being described by the appended claims and not by the foregoing description, and all modifications that fall within the meaning and scope of the claims are accordingly incorporated here. In other words it is considered that this includes all modifications, variations or equivalents that fall within the field of application of the underlying basic principles and whose essential attributes are claimed in this patent application. In addition, the reader of this patent application will understand that the words “comprising” or “comprise” do not exclude other elements or steps, and that the word “a” does not exclude the plural. Any references in the claims are not to be understood as a limitation of the claims in question. The terms “first”, “second”, “third”, “a”, “b”, “c” and the like, when used in the description or in the claims, are used for distinguishing between similar elements or steps and do not necessarily describe a sequential or chronological order. Similarly, the terms “top”, “bottom”, “above”, “below” and such are used for the purpose of description and they do not necessarily refer to relative positions. It is to be understood that these terms are mutually interchangeable in the right circumstances and that embodiments of the invention are able to function according to the present invention in other orders or orientations than those described or illustrated in the foregoing.

1.-15. (canceled)

16. An apparatus suitable for a hydrogen application, said apparatus comprising:
a hydrogen preparation unit adapted for supplying a hydrogen-containing gaseous medium with at least 85 volume percent hydrogen, at a pressure which, depending on the operating state of said apparatus, is between a lower limit and an upper limit, wherein said lower limit is less than or equal to said upper limit;
a hydrogen collector unit in communication with said hydrogen preparation unit, comprising one or more pipe elements which together define an interior space delimited by a wall;
a hydrogen processing unit in communication with said hydrogen collector unit, adapted for the processing and/or use of said hydrogen-containing medium,
wherein said apparatus is adapted for, during operation,
feeding said hydrogen collector unit with said hydrogen-containing medium from said hydrogen preparation unit, for flow and/or temporary buffering of said hydrogen-containing medium in said interior space, wherein said wall is in contact with said hydrogen-containing medium, and wherein in said interior space there is a pressure being at most equal to said upper limit, and a temperature of at most 100° C.;
supplying said hydrogen-containing medium from said hydrogen collector unit to said hydrogen processing unit,
wherein said upper limit for said pressure is at most 50 bar, and each of said one or more pipe elements is a casting, made from a nodular cast iron with a tensile strength of at most 600 MPa.

17. The apparatus according to claim 16, wherein said upper limit for said pressure is at least 5 bar and is at most 50 bar, for example is equal to 10 bar.

18. The apparatus according to claim 16, wherein said apparatus is a hydrogen combustion engine, in which
said hydrogen-containing gaseous medium functions as gaseous fuel, comprising at least 85 volume percent hydrogen;
said one or more pipe elements of said hydrogen collector unit together form a fuel rail, and
said hydrogen processing unit comprises one or more injectors, and a combustion chamber per injector, and
wherein said hydrogen combustion engine is adapted to, during operation,
temporarily buffer said hydrogen-containing medium in said fuel rail, at a temperature of at most 100° C., and at a pressure which, depending on the operating mode of said hydrogen combustion engine, is situated between said lower limit and said upper limit, and
distribute said hydrogen-containing medium from said fuel rail to said injectors, for combustion in said combustion chambers.

19. The apparatus according to claim 16, wherein said nodular cast iron meets grade EN-GJS-400 or EN-GJS-450 or EN-GJS-500 according to European standard DIN EN 1563, grade EN-GJS-400.

20. The apparatus according to claim 16, wherein said nodular cast iron has a tensile strength between 400 MPa and 500 MPa.

21. The apparatus according to claim 16, wherein said hydrogen preparation unit is adapted for supplying said hydrogen-containing gaseous medium, at a pressure which, in the nominal operating state of said apparatus, is situated between 3 and 4 bar, for example 3.5 bar.

22. The apparatus according to claim 16, wherein said lower limit for said pressure is at least 0.1 bar and at most 1 bar, for example 0.3 bar.

23. The apparatus according to claim 16, wherein each of said pipe elements is made double-walled, wherein a pipe element comprises a second wall, placed around said wall,
wherein said second wall is separated at least partially from said wall by a cavity.

24. The apparatus according to claim 16, wherein said pipe elements consist of tubing pieces and branch pieces,
wherein each of said tubing pieces comprises a sleeve,
wherein said sleeve has an end adapted to be connected to an adjacent tubing piece, so that tubing pieces linked together form a continuous tube, and
wherein said tubing piece has a transverse opening made in said sleeve,
each of said branch pieces comprises a sleeve, wherein said sleeve has an end adapted to be connected to a tubing piece, at the position of said transverse opening, so that a branch is formed on said continuous tube.

25. The apparatus according to claim 16, wherein said hydrogen preparation unit comprises an expansion system placed between a high-pressure line and a low-pressure line and comprising one or more pressure controllers, said expansion system being adapted to reduce the pressure of said hydrogen-containing medium delivered via said high-pressure line to a pressure between said lower limit and said upper limit in said low-pressure line,
wherein said low-pressure line is connected to said hydrogen collector unit.

26. The apparatus according to claim 25, wherein said one or more pressure controllers comprise: one or more pressure regulating valves, adapted to reduce said pressure to a set value situated between said lower limit and said upper limit, and/or one or more overpressure valves, adapted to reduce said pressure to a discharge value equal to said upper limit.

27. The apparatus according to claim 18, wherein said hydrogen combustion engine has a power of at least 500 kW.

28. Use of a hydrogen collector unit, said use comprising:
providing a hydrogen collector unit comprising one or more pipe elements which together define an interior space delimited by a wall;
providing a hydrogen-containing gaseous medium, with at least 85 volume percent hydrogen;
causing said hydrogen-containing medium to flow and/or temporarily buffering said hydrogen-containing medium and/or storing said hydrogen-containing medium in said interior space, at a temperature of at most 100° C. and at a pressure situated between a lower limit and an upper limit, wherein said wall is in contact with said hydrogen-containing medium, and
wherein said lower limit is less than or equal to said upper limit;
wherein said upper limit for said pressure is at most 50 bar, and each of said one or more pipe elements is a casting, made from a nodular cast iron with a tensile strength of at most 600 MPa.

29. The use according to claim 28, wherein said use comprises:
providing a hydrogen preparation unit, in communication with said hydrogen collector unit;
providing a hydrogen processing unit, in communication with said hydrogen preparation unit;
supplying said hydrogen-containing medium by said hydrogen preparation unit, at a pressure which, depending on the operating state of said apparatus, varies between said lower limit and said upper limit;
feeding said hydrogen collector unit with said hydrogen-containing medium, from said hydrogen preparation unit,
wherein said hydrogen-containing medium flows in and/or is buffered temporarily in said interior space;
supplying said hydrogen-containing medium from said hydrogen collector unit to said hydrogen processing unit;
processing and/or using said hydrogen-containing medium in said hydrogen processing unit.

30. The use according to claim 29, wherein said hydrogen collector unit is a fuel rail, used in a hydrogen combustion engine, and wherein
said hydrogen-containing medium functions as fuel, comprising at least 85 volume percent hydrogen;
said hydrogen processing unit comprises one or more injectors, and a combustion chamber per injector, said use comprising:
temporarily buffering said hydrogen-containing medium in said fuel rail, at a temperature of at most 100° C. and at a pressure which, depending on the operating mode of said hydrogen combustion engine, varies between said lower limit and said upper limit;
distributing said hydrogen-containing medium from said fuel rail to said injectors;
burning said hydrogen-containing medium in said combustion chambers.
